(19) United States
(12) Patent Application Publication
(10) Pub. No.: US 2009/0020666 A1
(43) Pub. Date: Jan. 22, 2009

(54) STAND ARRANGEMENT AND STAND FOR A MEDICO-OPTICAL INSTRUMENT

(75) Inventor: Roland Brenner, Wallhausen (DE)

Correspondence Address: CASELLA & HESPOS, 274 MADISON AVENUE, NEW YORK, NY, 10016, US

(73) Assignee: CARL ZEISS SURGICAL GMBH, Oberkochen (DE)

(21) Appl. No.: 12/176,446

(22) Filed: Jul. 21, 2008

(30) Foreign Application Priority Data
Jul. 20, 2007 (DE) 10 2007 034 286.3

(51) Int. Cl. F16M 11/00

(52) U.S. Cl. 248/176.1

(57) ABSTRACT

A stand (1) for a medical-optical instrument (3) is made available, with a link arrangement (15) having at least one link (13, 17, 19, 21) and with an active vibration damping device (33, 35, 37) which comprises at least one vibration pick-up (33) for picking up a vibration to be damped and at least one actuator (37) for generating a damping countervibration. The at least one actuator (37) is arranged on the surface of a link (19) of the link arrangement (15) at a distance from a vibration antinode of the vibration to be damped and is designed for exerting a force on the link (19).

### BACKGROUND OF THE INVENTION

1. Field of the Invention

The present invention relates to a stand for a medical-optical instrument, with a link arrangement having at least one link and with an active vibration damping device. In addition, the invention relates to a stand arrangement with a stand of this type, with a mounting, arranged on the link arrangement, for the medical-optical instrument, and with a medical-optical instrument fastened to the mounting of the stand.

2. Description of the Related Art

For example a stand for neurosurgery carries, as a rule, an operating microscope with a magnification up to 30 times. However, the stand, as a mechanical structure, has only finite rigidity and therefore experiences some deformation under load. It is technically not possible to construct the stand with infinite rigidity. Moreover, high rigidity also entails a very high deadweight.

Finite rigidity causes the stand to become a vibratory system, that is to say the stand may be excited into vibrations by being knocked or by a low external periodic force. If the stand vibrates, the image quality of the operating microscope is influenced considerably, thus entailing disadvantages particularly in neurosurgical operations.

Knocking, in practice, cannot be prevented. It is possible, however, after a knock, to keep the vibration die-out time of the stand as low as possible in structural terms. This takes place, as a rule, by means of suitable damping in the rotary joints which are part of the stand. By contrast, if the stand is not only knocked, but also excited by a periodic force, then only very little can be done against the vibrations thereby induced. Periodic forces may be caused, for example, by building vibrations, vibrations of air conditioning systems or by fans. Particularly in the case of ceiling stands which are firmly connected mechanically to the ceiling of a building, susceptibility to vibrations is particularly high. Unfortunately, dampers of a conventional type of construction, such as, for example, rubber buffers, do little and, under certain circumstances, may even worsen the vibrations due to resonances on account of their transmission behavior under periodic excitation.

Stands have therefore been proposed in which, in particular, periodically excited vibrations are to be suppressed by means of active vibration damping.

Thus, for example, DE 10 2004 004 602 A1 and DE 10 2004 063 606 A1 describe stands and holding devices with active vibration damping, in which there are control loops which for vibration damping act on a drive of the stand or of the holding device.

US 2001/002432 A1 discloses a microscope with a dynamic damper which is arranged in the microscope in the region of the free end of a holding arm of the stand. Active vibration damping thus takes place at the point where the vibration to be damped gives rise to the greatest deflection.

DE 43 245 38 A1 and DE 43 427 17 A1 describe microscope stands which contain a force-exerting device for active vibration damping. The force-exerting device is arranged between a vertical carrying arm and a horizontal carrying arm or between a vertical carrying arm and an operating microscope.

EP 1 447 700 A2 describes a microscope with a stand, the microscope and/or the stand having at least one carrying part and a vibration compensation device. Vibration compensation device is a self-regulating structural element which, on the basis of the measurement of vibrations, activates integrated drive elements such that these counteract the vibration in real time in such a way that the vibration does not lead to a change in position of the outer contours or of the critical interfaces on the component. Structural elements of this type are described under the term “ARES structural elements” from the article by E. J. Breitbach et al.: “Adaptive Structure—Concepts and Prospects” of the Institute of Aeroelasticity and of the Institute of Structural Mechanics of the German Center for Aeronautics and Astronautics, pages 3 to 8 (publication date unknown). In this context, ARES stands for Actively Reacting Flexible Structure. ARES structural elements, in EP 1 447 700 A2, are arranged, in particular, at a potential location for the occurrence of vibration antinodes.

In light of this prior art, the object of the present invention is to make available an advantageous stand for holding a medical-optical instrument and also an advantageous stand arrangement comprising a stand, a holder device for a medical-optical instrument and a medical-optical instrument arranged on the mounting.

### SUMMARY OF THE INVENTION

A stand according to the invention for a medical-optical instrument, which stand may be designed both as a floor stand and as a ceiling stand, comprises a link arrangement having at least one link and an active vibration damping device. The active vibration damping device is equipped with at least one vibration pick-up for picking up a vibration to be damped and with at least one actuator for generating a damping countervibration. The at least one actuator is arranged on the surface of a link at a distance from a vibration antinode of the vibration to be damped and is designed for exerting a force on the link, for example on the surface of the link. In this context, the surface may be an outer surface of the link or, in the case of a hollow link, an inner surface.

By the actuator being arranged at a distance from a vibration antinode of the vibration to be damped, it is possible to damp the vibration to be damped by exerting a force on the link, for example on the surface of the link, without the actuator having to bring about a pronounced deflection of the link. In this case, within the scope of the invention, the vibratory capacity of the stand, which has hitherto actually been considered a disturbing property, is utilized in order to generate a suitable countervibration at the location of the vibration antinode, for example at the free end of a carrying arm. In contrast to this, in the prior art, in which the actuators are arranged in the region of the vibration antinode, that is to say at the location of maximum deflection, greater actuator movements are necessary in order to compensate the movement in the vibration antinode.

Vibrations can be damped by means of particularly low actuator movements if at least one actuator is arranged at or in the vicinity of that point on the link at which the load, acting on the link, of the medical-optical instrument generates the highest mechanical tension on the surface of the link or the highest moment of flexion in the link. At this point, actuator movements can be fed into the link particularly effectively in order to generate a countervibration.

In particular, at least two actuators may be present which are arranged on surface regions of the link which are not parallel to one another. This refinement makes it possible to damp vibrations actively in two directions perpendicular to one another.

In an advantageous refinement of the stand according to the invention, the link of the link arrangement is a carrying arm, to which a mounting for the medical-optical instrument is to be fastened. This carrying arm has a particular tendency to vibrations, since, as a rule, there is a relatively long distance between a bearing point of the carrying arm and the free end of the carrying arm to which the mounting is to be fastened.

The actuator for generating the countervibration may comprise, in particular, a piezoelectric material. It may, for example, be a piezoceramic actuator. Piezoceramic actuators occur in a piezo-stack type of construction, a piezo-film type of construction and a piezo-fiber type of construction and may also be used as such in the stand according to the invention. On account of their flexibility, piezoceramic actuators are suitable for use in the stand according to the invention particularly when they are embodied in the piezo-film type of construction or in the piezo-fiber type of construction.

Alternatively, the piezoelectric material may also be a ferroelectric material, for example a ferroelectric plastic, such as, for example, polyvinylidene fluoride. Ferroelectric plastics, in particular, make it possible to have a largely free shaping for the actuators and therefore an optimal adaption of the actuator shape to the surface geometry of the link.

Instead of a piezoelectric material, however, the actuator may also comprise a magnetic mass oscillator with a mass capable of being excited magnetically to vibrate and with an electromagnetic excitation device for exciting a vibration of the mass. Besides taking the form of a magnetic solid body, the mass of the mass oscillator capable of being excited to vibrate may also take the form of a ferromagnetic or magnetorheological liquid located in a vessel. A conductive magnetic liquid which is suitable for use in an actuator is described, for example, in US 2007/0114486 A1. Reference is made with regard to suitable liquids to this publication. The vibration of the mass can be controlled in terms of its amplitude, its frequency and its direction in a simple way by means of a suitably applied electromagnetic field. In this case, in particular, the use of a liquid as a mass oscillator affords the possibility of generating different geometric vibrations by means of one and the same oscillator. Moreover, ferrofluids possess a very low hysteresis, this being advantageous for the control process.

The vibration pick-up of the active vibration damping device may be, in particular, an acceleration sensor to be fastened to the medical-optical instrument or to the mounting of the medical-optical instrument. Particularly when it is fastened to the instrument itself, it allows an accurate determination of the actual instrument vibration.

Alternatively, however, it is also possible to design the vibration pick-up as a flexion sensor or tension sensor which is arranged at or in the vicinity of a point on a link of the link arrangement at which the load, acting on the link, of the medical-optical instrument generates the highest elastic deformation and consequently the highest mechanical surface tension and the highest moment of flexion. To be precise, at this point, a vibration also generates a clearly measurable deformation which can be determined in a simple way by means of the flexion sensor or the tension sensor. Flexion or tension sensors which may be considered in this context are, for example, piezoelectric or ferroelectric elements which basically function according to the same principle as a piezoelectric actuator or a ferroelectric actuator and may also possess a corresponding set-up. Whereas, where the actuator is concerned, deformation is brought about by the application of an electrical field, the opposite process is utilized in the case of the flexion or tension sensor, to be precise a deformation of the piezoelectric or ferroelectric element leads to a measurable tension which makes it possible to determine the vibration.

A stand arrangement according to the invention comprises a stand according to the invention, a mounting, arranged on the link arrangement, for the medical-optical instrument and a medical-optical instrument which is fastened to the mounting and which may be, in particular, an operating microscope. By virtue of the advantageous active vibration damping described with reference to the stand, the stand system according to the invention makes it possible to work with the medical-optical instrument without disturbing vibrations. In this case, the actuator may also be arranged on a link of the mounting, which link may in this respect also be considered as part of the stand and its link arrangement, even if the mounting is, as a rule, an independent component. When a link of the link arrangement is referred to in connection with the stand according to the invention, this is therefore also to be understood as meaning a link of a mounting fastened, if appropriate, to the stand.

Further features, properties and advantages of the present invention may be gathered from the following description of exemplary embodiments, with reference to the accompanying figures.

### BRIEF DESCRIPTION OF THE DRAWINGS

FIG. 1 shows a first exemplary embodiment of a stand system with a stand according to the invention.

FIG. 2 shows a second exemplary embodiment of a stand system with a stand according to the invention.

FIG. 3 shows a third exemplary embodiment of a stand system with a stand according to the invention.

FIG. 4 shows a detail from FIG. 3.

FIG. 5 shows a fourth exemplary embodiment of a stand system with a stand according to the invention.

FIG. 6 shows a fifth exemplary embodiment of a stand system with a stand according to the invention.

FIG. 7 shows the profile of surface tensions in a link loaded at the free end.

### DETAILED DESCRIPTION OF THE PREFERRED EMBODIMENTS

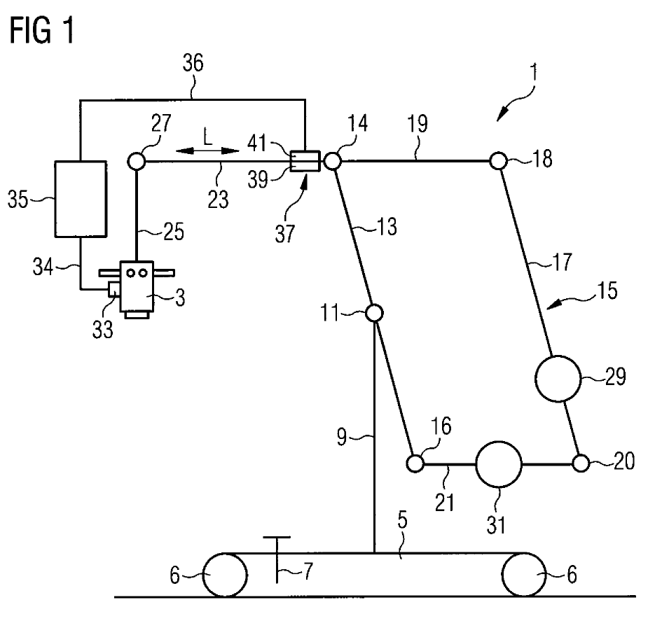

A first exemplary embodiment of a stand system with a stand 1 according to the invention and with an operating stereo microscope 3 as a medical-optical instrument is illustrated highly diagrammatically in FIG. 1. The stand 1 rests on a stand foot 5, on the underside of which rollers 6 are present which make it possible to move the stand. In order to prevent unwanted movement, moreover, the stand foot 5 possesses a foot brake 7. A stand column 9 (or a bracket) is arranged on the stand foot 5 and has a joint 11, to which a first link 13 of a link arrangement 15 is fastened in a pivotably movable manner. Moreover, the stand column 9 also has a rotary joint, not illustrated in the figure.

At the two opposite ends of the first link 13, joints 14, 16 are present, via which a first transverse link 19 and a second transverse link 21 are connected to the first link 13 in a pivotably movable manner. A second link 17 is connected to the first transverse link 19 or the second transverse link 21 by joints 18, 20, located essentially at its two opposite ends, in such a way that a joint arrangement 15 in the form of a parallel rod assembly is obtained.

The first transverse link 19 is prolonged with respect to the second transverse link 21 and projects beyond the parallel rod assembly. The joint 14 may in this case be considered as a bearing or bearing joint of the projecting portion. A microscope mounting 25 is arranged in a rotationally and pivotably movable manner via a joint 27 at the free end of the projecting portion 23 of the transverse link 19. The microscope mounting 25 may be either an independent component or an integral part of the stand 1. The operating stereo microscope 3 is fastened to the microscope mounting 25.

To compensate the weight of the operating microscope 3, compensating weights 29, 31 are arranged on the second link 17 and on the second transverse link 21 and ensure that no resultant torques persist on account of the weight of the operating microscope 3. Basically, therefore, no motors and brakes are necessary for moving the microscope. Nevertheless, electric motors may be present in the individual joints, in order to allow a motor-driven movement of the stand 1. Moreover, the joints may have brakes, by means of which they can be secured against unwanted movement.

For example, building vibrations may be transmitted to the stand 1 via the wheels 6 and the brake 7 and lead to a vibration of the projecting portion 23 of the first transverse link 19 designed as a carrying arm. In this context, the operating microscope 3, together with the microscope mounting 25, is to be considered as a vibrating mass. The vibration leads to a deflection in the region of the joint 27, which, in turn, induces mechanical tensions in the surface of the link 19. The tension profile, which is induced by the weight force of the operating microscope 3 and of the mounting 25 in the first transverse link 19, is outlined in FIG. 7. The tension σ rises linearly from the joint 27 in the direction of the bearing joint 14 and reaches its maximum value at the bearing joint 14. It then decreases linearly again from the bearing joint 14 to the joint 18. If, then, there is a vibration of the first transverse link 19, the result of this is that the weight force acting on the free end of the link 19 has superposed on it periodically a force which results from the acceleration of the microscope 3 generated by the vibration. This is reflected in a periodic variation of the tensions σ in the surface of the first link 19.

So that vibrations transmitted to the microscope 3 can be damped, the stand 1 is equipped with an active vibration damping system. This comprises a vibration pick-up 33 which, in the present exemplary embodiment, is designed as an acceleration sensor to be attached to the operating microscope 3. Furthermore, the device comprises a controller 35 and an actuator arrangement 37. An acceleration detected by the acceleration sensor 33 on account of a vibration of the operating microscope 3 is converted into an acceleration signal and is transferred to the controller 35 by a signal line 34. A countervibration to be generated is determined there by means of a suitable control algorithm on the basis of the acceleration signal and is capable of extinguishing the vibration of the operating microscope 3 by destructive interference. On the basis of the countervibration, an actuating signal is output to the actuator arrangement 37 by the controller 35 via the signal line 36. The actuating signal causes the actuator arrangement to generate in the first transverse link 19 the countervibration determined by the controller 35.

In the present exemplary embodiment, the actuator arrangement 37 comprises two piezoceramic elements 39, 41 which are designed as piezo-fiber elements. One of the piezo-fiber elements 39 is arranged, directly in front of the bearing joint 14, on the underside of the first transverse link 19. The second piezo-fiber element 41 is likewise arranged, directly in front of the bearing joint 14, on the top side of the first transverse link 19. The two piezo-fiber elements 39, 41 are connected firmly to the surface of the first transverse link 19 and can therefore, by contraction and expansion in the longitudinal direction L of the first transverse link 19, induce tensions in the surface of the latter. If, then, mechanical tension is present in the surface on account of the microscope vibration and leads to an expansion in the region of the upper piezo-fiber element 41, this tension can be counteracted by a contraction of this piezo-fiber element 41, so that it can be cancelled. If this counteraction takes place at the frequency of the vibration to be damped, destructive indifference occurs, which leads to the extinguishing of the vibration to be damped.

Although, in the present exemplary embodiment, two piezo-fiber elements 39, 41 are present, it is basically sufficient to provide one piezo-fiber element, insofar as the piezo-fiber element allows both expansion and contraction. If, however, the piezo-fiber element is designed merely such that it can execute either contraction or expansion, but not both, then, as illustrated, piezo-fiber elements may be arranged on opposite surfaces of the link 19. Depending on whether the vibration leads precisely to an upward or downward deflection of the first transverse link, at least one of the two piezo-fiber elements would then be activated in order to compensate the deflection.

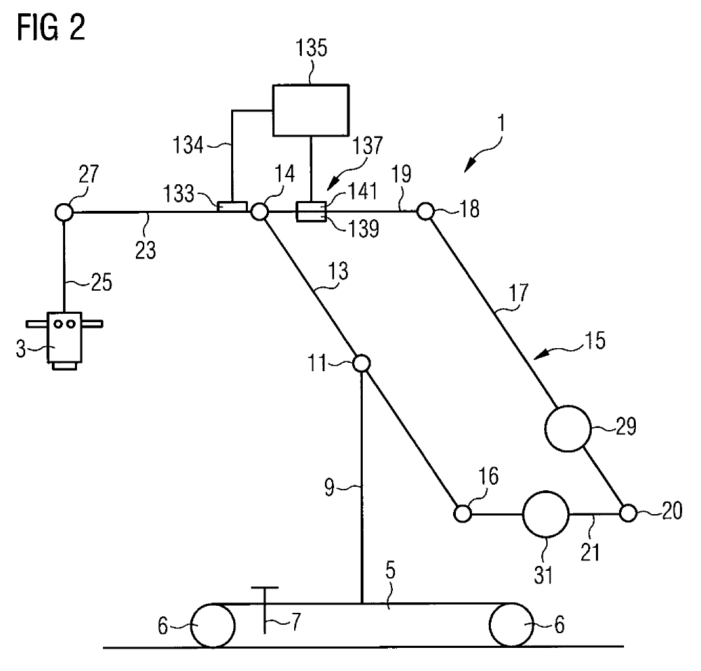

A second exemplary embodiment of the stand according to the invention is illustrated in FIG. 2. The mechanical set-up of the stand does not differ from the mechanical set-up of the stand shown in FIG. 1 and is therefore not described once again in order to avoid repetition.

The difference of the stand shown in FIG. 2 from the stand shown in FIG. 1 is solely in the vibration damping device. In the second exemplary embodiment, the vibration damping device comprises a vibration pick-up 133 which is designed as a flexion sensor, a controller 135 and an actuator arrangement 137. The controller 135 is connected to the flexion sensor 133 via a signal line 134 for the reception of a flexion signal and is connected to the actuator arrangement 137 via a signal line 136 for the output of an actuating signal. The flexion signal in this case represents a moment of flexion caused by the vibration to be damped.

The flexion sensor 133 used may be a piezo-electric element, for example a piezoelectric ceramic. This is designed such that it generates an electrical voltage when it is bent, the amount of the voltage depending on the extent of the flexion of the piezoelectric sensor 133. The moment of flexion occurring on account of a force acting on the free end of the first transverse link exhibits a profile which corresponds to the profile, illustrated in FIG. 7, of the surface tensions σ, that is to say has a maximum at the bearing joint 14. A vibration of the operating microscope 3 therefore generates, in the region of the bearing joint 14, a maximum moment of flexion which is most suitable for detecting a vibration.

On the basis of the detected moment of flexion, the controller 135 calculates a suitable countervibration and outputs an actuating signal representing the countervibration to the actuator arrangement 137.

In the present exemplary embodiment, the actuator arrangement 137 is designed in the form of two stack piezoelements 139, 141. These are set up such that, when a suitable voltage is applied, they generate in the first transverse link 19 a moment of flexion which is opposite to the moment of flexion generated by the vibration to be damped. Thus, the countervibration can be introduced into the first transverse link 19, so that the vibration to be damped is cancelled by destructive interference. Instead of being arranged one behind the other, as in the present exemplary embodiment, the flexion sensor and the piezoelements of the actuator may also be arranged next to one another transversely to the longitudinal direction of the link 19.

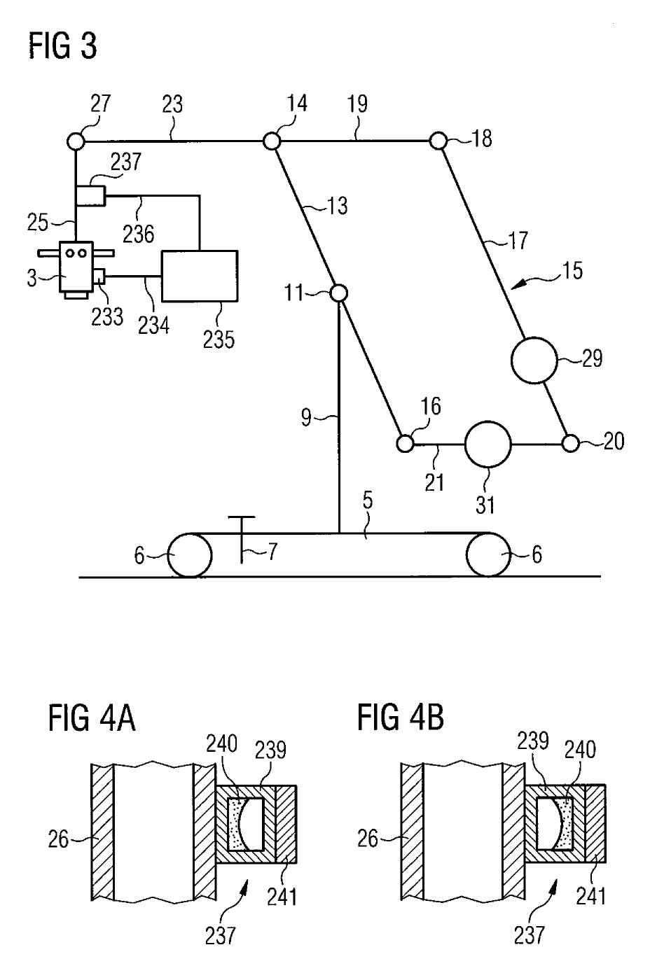

FIG. 3 shows a third exemplary embodiment of a stand device with a stand 1 according to the invention. The stand 1 corresponds in its mechanical set-up to that of the two preceding exemplary embodiments. Its mechanical elements are therefore designated by the same reference numerals as in these two exemplary embodiments and are not explained again in order to avoid repetition.

The third exemplary embodiment differs from the other two exemplary embodiments in its active vibration damping device. This comprises a vibration pick-up 233 to be attached to the operating microscope 3, a controller 235 and an actuator 237 which, in the present exemplary embodiment, is not arranged on the first transverse link 19 representing the carrying arm, but, instead, on a link of the microscope mounting 25. As in the first exemplary embodiment, the vibration pick-up 233 is designed as an acceleration sensor and is connected to the controller 235 via a signal line 234 for the output of an acceleration signal representing the microscope acceleration. Moreover, the controller is connected to the actuator 237 via a signal line 236 for the output of an actuating signal.

The controller 235 contains a control algorithm which determines a suitable countervibration for damping the microscope vibration on the basis of the received acceleration data and which outputs a suitable actuating signal for generating the countervibration to the actuator 237. The actuator 237 then generates the countervibration which leads to destructive interference with the vibration to be damped, as a reaction to the actuating signal.

In the present exemplary embodiment, the actuator 237 used is a mass oscillator which comprises a magnetic mass capable of being excited to vibrate and an electromagnetic excitation device, by means of which the magnetic mass can be excited to vibrate. The mass oscillator is illustrated diagrammatically in FIGS. 4a and 4b. The figures show a detail of a hollow link 26 of the microscope mounting 25, to the outside of which the mass oscillator 237 is fastened. However, alternatively, it may also be arranged inside the link 26. The mass oscillator 237 comprises a container 239 in which a ferromagnetic liquid 240 is located and which is fastened to the link 26. An electromagnet 241, by means of which a magnetic alternating field can be generated, is fastened to that side of the container 239 which faces away from the link 26. Depending on the polarization of the magnetic alternating field, the ferroelectric liquid 240 is pressed either in the direction of the link 26 (FIG. 4A) or in the direction of the electromagnet 241 (FIG. 4B). Thus, with the aid of the magnetic alternating field, a vibration of the liquid 240 in the container 239 can be brought about, which is transmitted to the link 26. The control of the electromagnet is effected by the controller 235 such that the vibration induced in the link 26 cancels by destructive interference the vibration of the operating microscope 3 to be damped. Instead of a ferroelectric liquid, a magnetorheological liquid may also be used, which likewise reacts to magnetic fields, but in this case changes its viscosity. By contrast, a ferroelectric liquid when a magnetic field is applied does not change its viscosity.

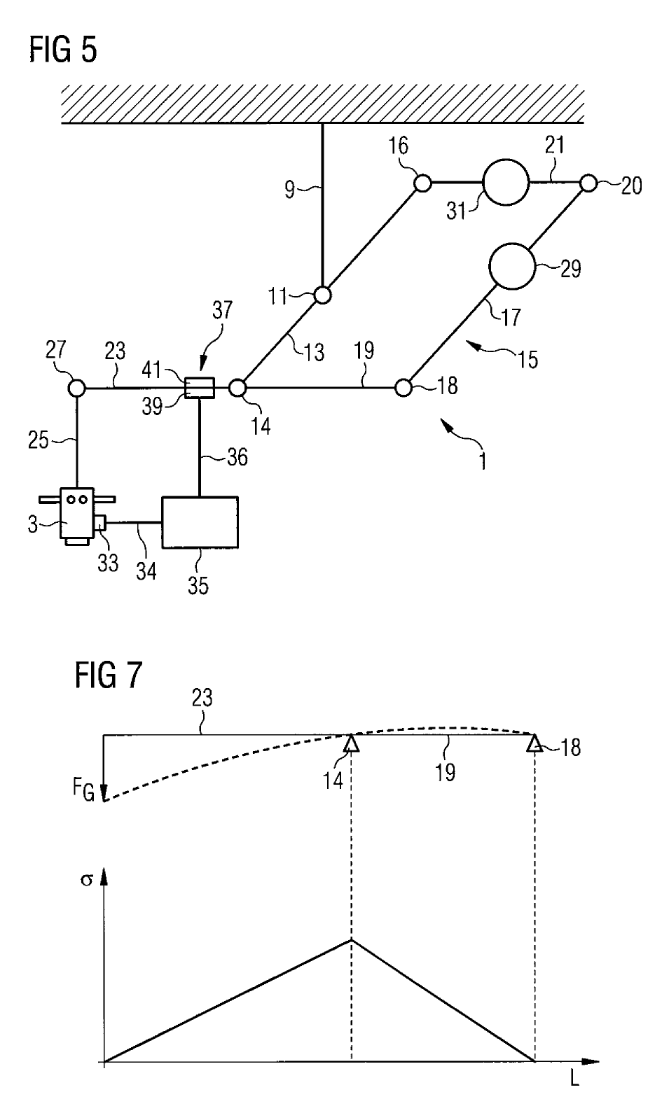

A fourth exemplary embodiment of the stand device according to the invention is illustrated in FIG. 5. This exemplary embodiment corresponds to the exemplary embodiment described with reference to FIG. 1, the difference being that the stand 1 is not a floor stand, as in the first exemplary embodiment, but a ceiling stand. Instead of being arranged on a stand foot, the stand column 9 is suspended on the ceiling. Undesirable vibrations may be fed into this stand 1, for example, by the ceiling. The active vibration damping device corresponds entirely to that of the first exemplary embodiment.

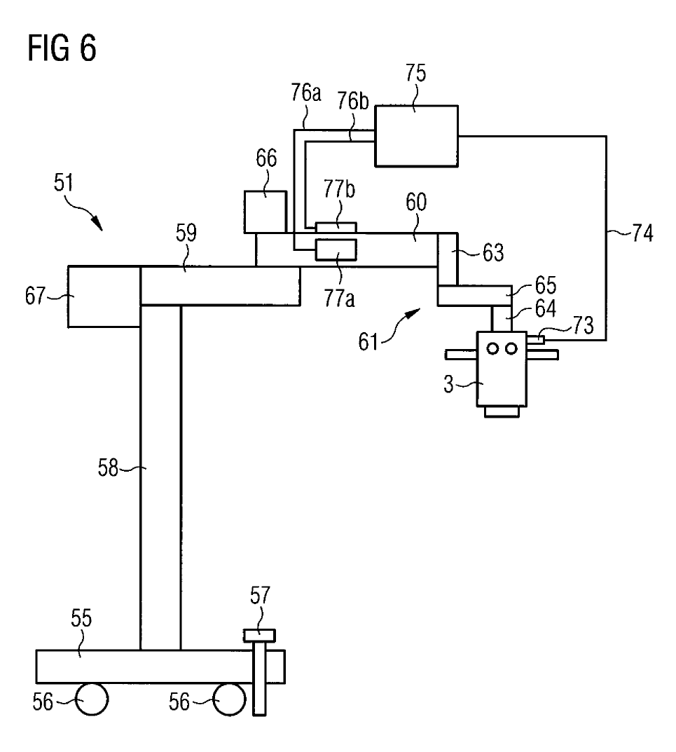

A fifth exemplary embodiment of a stand device with a stand according to the invention is illustrated in FIG. 6. The stand 51 is a mobile motor stand with increased stability. It comprises a stand foot 55, on the underside of which rollers 56 are present which allow a movement of the stand 51. In order to prevent an unwanted movement of the stand 51, moreover, the stand foot 55 possesses a foot brake 57. Furthermore, the stand comprises as stand members a height-adjustable stand column 58, a carrying arm 59, a spring arm 60 and a microscope suspension or mounting 61 which, in turn, comprises a connection element 63, a pivoting arm 65 and a holding arm 64. The microscope mounting 61 may also be considered as an independent unit which is not part of the stand. An operating microscope 3 is fastened to the microscope mounting 61. Moreover, the stand 51 has arranged on it a light source 66 for object illumination and also a mains connection unit and an operating element 67 for electrical components of the microscope 3 and the stand 51. Both the lamps and the supply unit may generate vibrations, for example when a cooling of these units is necessary. Moreover, as with a stand which is not motor-driven, too, vibrations may be picked up from the floor via the stand foot 55 and the wheels 56. The stand 51 therefore comprises an active vibration damping device with a vibration pick-up 73 designed as an acceleration sensor, with a controller 57 and with two actuators 77a, 77b. The controller 75 is connected to the acceleration sensor 73 via a signal line 74 for the reception of an acceleration signal and, for the output of actuating signals, to the actuators 77a, 77b via two signal lines 76a, 76b. In the present exemplary embodiment, the actuators used are piezoelectric elements in a stack type of construction. These, when a suitable voltage is applied, generate a moment of flexion acting on the spring arm 60. When an alternating voltage is applied, a vibration can thus be induced in the spring arm. In this case, the controller 75 determines the actuating signals for the actuators 77a, 77b on the basis of the received acceleration signal, in such a way that a countervibration to a detected microscope vibration is generated, which damps the detected microscope vibration by destructive interference.

In the exemplary embodiments described, piezoceramic actuators and an actuator with a magnetic mass oscillator and with an electromagnetic excitation device are used. However, other actuators, for example ferroelectric actuators, may also be employed. Ferroelectric materials form a subgroup of piezoelectric materials which can be used for producing actuators having a very precise action and are therefore particularly suitable for the production of actuators for the damping of vibrations in stands.

The present invention makes available a possibility for actively damping vibrations in stands for medical-optical instruments effectively. In this case, by means of actuators, either a mechanical countertension on the surface of a link is generated, which compensates the mechanical tension resulting from the vibration to be damped, or a moment of flexion is provided which compensates the moment of flexion of the link resulting from the vibration to be damped. In both instances, the actuator is arranged on the surface of a link at a distance from a vibration antinode of the vibration to be damped. In particular, it is advantageous if the actuator is arranged at or in the vicinity of that point having the highest moment of flexion induced by the vibration to be damped or having the highest mechanical surface tension in the carrier induced by the vibration to be damped.

What is claimed is:

1. A stand (1, 51) for a medical-optical instrument (3), with
a link arrangement (15) having at least one link (13, 17, 19, 21, 26, 60), and
an active vibration damping device (33, 35, 37, 73, 75, 77, 133, 135, 137, 233, 235, 237) which comprises at least one vibration pick-up (33, 73, 133, 233) for picking up a vibration to be damped and at least one actuator (37, 77, 137, 237) for generating a damping countervibration,
characterized in that
the at least one actuator (37, 77, 137, 237) is arranged on the surface of a link (19, 26, 60) of the link arrangement (15) at a distance from a vibration antinode of the vibration to be damped and is designed for exerting a force on the link (19, 26, 60).

2. The stand (1, 51) of claim 1, characterized in that the at least one actuator (37, 77, 137, 237) is arranged at or in the vicinity of a point (14) on a link (19, 26) of the link arrangement (15) where the load, acting on the link (19, 26), of the medical-optical instrument (3) generates the highest mechanical tension on the surface of the link (19, 26, 60) or the highest moment of flexion in the link (19, 26, 60).

3. The stand (51) of claim 1, characterized in that at least two actuators (77a, 77b) are present which are arranged on surface regions of the link (60) which are not parallel to one another.

4. The stand (1, 51) of claim 1, characterized in that the link (19, 60) of the link arrangement (15) is a carrying arm, to which a mounting for the medical-optical instrument (3) is to be fastened.

5. The stand (1, 51) of claim 1, characterized in that at least one actuator (37, 77, 137) comprises a piezoelectric material.

6. The stand (1, 51) of claim 5, characterized in that the actuator (37, 77, 137) is a piezoceramic actuator.

7. The stand (1, 51) of claim 5, characterized in that the piezoelectric material is a ferroelectric material.

8. The stand (1) of claim 1, characterized in that the at least one actuator (237) comprises a magnetic mass oscillator with a mass (240) capable of being excited magnetically to vibrate and an electromagnetic excitation device (241) for exciting a vibration of the mass (240).

9. The stand (1) of claim 8, characterized in that the mass of the mass oscillator capable of being excited to vibrate is a ferromagnetic or magnetorheological liquid (240) located in a vessel (239).

10. The stand (1, 51) of claim 1, characterized in that the vibration pick-up (33, 73, 237) is an acceleration sensor to be fastened to the medical-optical instrument (3) or its mounting.

11. The stand (1) of claim 1, characterized in that the vibration pick-up (133) is a flexion sensor or a tension sensor which is arranged at or in the vicinity of a point on a link (19) of the link arrangement (15) at which the load, acting on the link (19), of the medical-optical instrument (3) generates the highest elastic deformation.

12. A stand arrangement with the stand (1) of claim 1, and with a mounting (25), arranged on the link arrangement, for the medical-optical instrument (3) and with a medical-optical instrument (3) fastened to the mounting (25).

13. The stand arrangement of claim 12, characterized in that the medical-optical instrument (3) is an operating microscope.
